(19) United States
(12) Patent Application Publication
(10) Pub. No.: US 2019/0314759 A1
(43) Pub. Date: Oct. 17, 2019

(54) PROCESS FOR THE REMOVAL OF HYDROGEN CHLORIDE AND SULFUR OXIDES FROM A GAS STREAM BY ABSORPTION

(71) Applicant: Haldor Topsøes Allé A/S, Kgs. Lyngby (DK)

(72) Inventors: Kresten Egeblad, Farum (DK); Jacob Brinch Frennegaard, League City, TX (US); Rasmus Trane-Restrup, Roskilde (DK); Niklas Bengt Jakobsson, Kågeröd (SE)

(21) Appl. No.: 16/464,805

(22) PCT Filed: Dec. 1, 2017
(86) PCT No.: PCT/EP2017/081225

§ 371 Date: May 29, 2019

(30) Foreign Application Priority Data
Dec. 22, 2016 (DK) PA 2016 00787

(51) Int. Cl. B01D 53/68; B01D 53/04; B01D 53/86; B01D 53/82; B01D 53/50; B01D 53/75; B01J 23/648; B01J 23/42; B01J 23/22

(52) U.S. Cl. CPC B01D 53/685; B01D 2258/05; B01D 53/8687; B01D 53/8662; B01D 53/8603; B01D 53/82; B01D 53/508; B01D 53/75; B01J 23/6482; B01J 23/42; B01J 23/22; B01D 2251/304; B01D 2251/306; B01D 2251/606; B01D 2255/1021; B01D 2255/1023; B01D 2255/20707; B01D 2255/20723; B01D 2257/2045; B01D 2257/2064; B01D 2257/302; B01D 2257/304; B01D 2257/556; B01D 2257/708; B01D 53/04

(57) ABSTRACT

In a process for the removal of hydrogen chloride and/or sulfur oxides from a landfill gas stream, which contains impurities such as siloxanes, H₂S, organic and inorganic sulfides and volatile organic compounds (VOCs), the heated gas is passed through a siloxane removal bed, where siloxanes are absorbed and then through one or more sulfur removal beds, where hydrogen sulfide and/or organic sulfides are absorbed. The effluent is passed through a reactor containing an oxidation catalyst enabling catalytic oxidation of VOCs, organic and inorganic CI- and/or S-containing compounds, COS and CS₂ to their respective combustion products, and finally the effluent from the reactor is passed through one or more beds, where hydrogen chloride and/or sulfur oxides are absorbed.

The present invention relates to a process for the removal of hydrogen chloride and sulfur oxides from a hot gas stream by absorption. The gas stream consists of a gas originating from a landfill or an anaerobic digester or from another industrial operation comprising combustion of chlorine- and/or sulfur-containing compounds, said gas also containing impurities such as hydrogen sulfide, siloxanes and volatile organic compounds (VOCs).

More specifically, the invention relates to the removal of hydrogen chloride and sulfur oxides (SO₂ and/or SO₃) from a process gas stream by passing said gas stream through a bed containing one or more materials capable of absorbing HCl and SOx (SO₂ and/or SO₃) from the gas stream, thereby affording a gas effluent free from said compounds.

A common method for removing acid gases, i.e. gases containing significant quantities of H₂S and CO₂, from a process gas consists in using caustic scrubbing technology. Thus, U.S. Pat. No. 9,174,165 B1 describes a dry flue gas desulfurization system that uses dry sorbent injection of sodium bicarbonate for acidic gas (SO₂, SO₃, HCl, HF) removal from flue gas with integrated sodium bicarbonate sorbent regeneration by a dual alkali process. Likewise, US 2009/0241774 Al discloses a method of removing SOx from a flue gas, in which trona (a mineral that contains about 85-95% sodium sesquicarbonate [Na₂CO₃.NaHCO₃.2H₂O]) is used as a dry sorbent in the dry sorbent injection (DSI) process.

A biogas purification system and a method for removing sulfur and halogenated compounds and acidic reaction products from biogas is described in US 2015/0119623 A1. A catalyst comprising V₂O₅ on a metal oxide support is used for oxidation of sulfur and halogenated compounds, and a contaminant removal module containing alkali-impregnated carbon is used for removal of the acidic reaction products.

DE 10 2009 009 376 A1 describes a process for catalytically removing H₂S, halogen-containing and aromatic hydrocarbons and silicon-comprising compounds from landfill gas and removing acidic compounds using Al₂O₃ and alkaline additives. A similar process is disclosed in EP 1 997 549 B1.

Sorbents and sorption processes for sorption and separation of a large number of impurities from gas streams, such as natural gas, coal/biomass gasification gas, biogas, land-fill gas, reformate gas, ammonia syngas, refinery process gases and flue gases, are disclosed in WO 2008/127602 A2. The sorbents are primarily polymers supported on porous materials, and the process for separation or removal of the impurities from the gas stream is a two-stage process involving two different sorbents.

The primary benefit of the present invention is that it avoids the use of a caustic scrubber in the process of removing acid gases from the gas, and as such the invention offers a significantly lower cost alternative for certain gas compositions.

Thus, the present invention concerns a process for the removal of hydrogen chloride and/or sulfur oxides from a gas stream, which contains primarily some or all of the following compounds: methane, carbon dioxide, nitrogen, oxygen and water, and which also contains impurities such as siloxanes, hydrogen sulfide, organic and inorganic sulfides and volatile organic compounds (VOCs), said gas stream originating from a landfill or an anaerobic digester or another industrial operation producing a similar gas stream. The process according to the present invention comprises the steps of
heating the gas,
optionally passing the hot gas through a siloxane removal bed, where siloxanes are absorbed,
optionally passing the hot gas through one or more sulfur removal beds, where hydrogen sulfide and/or organic sulfides are absorbed,
passing the effluent from the said optional absorption beds through a reactor containing an oxidation catalyst, said catalyst enabling catalytic oxidation of VOCs, organic and inorganic chlorine- and/or sulfur-containing compounds, COS and CS₂ to their respective combustion products, and
passing the effluent from the reactor through one or more beds, where hydrogen chloride and/or sulfur oxides are absorbed.

Preferably the oxidation catalyst is a catalyst with increased oxidation activity as well as a negligible SO₂ selectivity. It is primarily selected among SMC catalysts (sulfur managing catalysts), i.e. vanadium/titania catalysts with or without palladium, including Applicant's catalysts containing precious metals, such as platinum, supported on silica or alumina.

The absorption bed materials for the hydrogen chloride and sulfur oxides absorption are preferably selected from oxides, hydroxides, carbonates, hydrogen carbonates and hydroxy carbonates of alkali metals or alkaline earth metals dispersed on high surface area carriers selected from alumina, silica and titania or mixtures thereof.

Preferably the alkali metals and alkaline earth metals are selected from potassium, sodium, magnesium and zinc.

Especially preferred absorption bed materials are K₂CO₃ and Na₂CO₃. Na or K compounds other than carbonates can be used, provided that Na or K is available for reaction on the surface.

Regarding the absorption of sulfur oxides, SO₃ is more demanding absorption-wise than SO₂, because it reacts spontaneously with any H₂O present in the gas, thereby creating hard-to-remove acid mist. Therefore, the carrier material should have a reasonably high pore volume.

The invention is illustrated further by the example which follows.

### EXAMPLE

A raw landfill gas, which is predominantly composed of CH₄, CO₂, N₂, H₂O and O₂, also contains impurities such as H₂S and organic chlorine- and sulfur-containing compounds as well as other impurities, e.g. siloxanes and VOCs.

After the gas heat-up step, the hot gas is passed through a siloxane removal bed, where any siloxanes are absorbed. Then the gas is passed through a hydrogen sulfide removal bed, where H₂S is absorbed, and from there it is passed through a reactor containing an oxidation catalyst. The oxidation catalyst is selected so as to facilitate catalytic oxidation of VOCs, organic chlorine- and sulfur-containing compounds, COS or CS₂ with O₂ to their respective combustion products, which means that the compounds are converted to a mixture of CO₂, H₂O, HCl, SO₂ and SO₃ still entrained in the process gas (predominantly consisting of CH₄, CO₂, N₂, H₂O and O₂).

According to the present invention, the process gas is passed through one or more beds where HCl, SO₂ and SO₃ are absorbed, optionally with concurrent release of one or more compounds from the sorbent material (in case of K₂CO₃ as sorbent: K₂CO₃+2 HCl→2 KCl+CO₂+H₂O). The invention is particularly useful since an application as described above, where the bulk of the sulfur —H₂S— is removed by absorption rather than by conversion to SO₂, allows for utilization of oxidation catalysts having an increased oxidation activity but at the same time being characterized by a low negligible SO₂ selectivity. This in turn entails that O₂ can be removed to even lower levels (and potentially also with less overdosing) than those which are attainable with SMC. Thus, exploiting the invention will also present benefits to various downstream CO₂ removal devices.

Furthermore, HCl, SO₂ and SO₂ are all corrosive in the presence of water and also poisonous to certain catalysts. Therefore, it is desirable to remove these compounds in order to protect piping and downstream equipment and catalysts.

1. A process for the removal of hydrogen chloride and/or sulfur oxides from a gas stream which contains primarily some or all of the following compounds: methane, carbon dioxide, nitrogen, oxygen and water, and which also contains impurities such as siloxanes, hydrogen sulfide, organic and inorganic sulfides and volatile organic compounds (VOCs), said gas stream originating from a landfill or an anaerobic digester or another industrial operation producing a similar gas stream, and said process comprising the steps of
heating the gas,
optionally passing the hot gas through a siloxane removal bed, where siloxanes are absorbed,
optionally passing the hot gas through one or more sulfur removal beds, where hydrogen sulfide and/or organic sulfides are absorbed,
passing the effluent from the said optional absorption beds through a reactor containing an oxidation catalyst,
said catalyst enabling catalytic oxidation of VOCs, organic and inorganic chlorine- and/or sulfur-containing compounds, COS and CS₂ to their respective combustion products, and
passing the effluent from the reactor through one or more beds, where hydrogen chloride and/or sulfur oxides are absorbed.

2. Process according to claim 1, wherein the oxidation catalyst is a catalyst with increased oxidation activity as well as a negligible SO₂ selectivity.

3. Process according to claim 1, wherein the oxidation catalyst is selected from vanadium/titania catalysts with or without palladium and catalysts containing precious metals, such as platinum, supported on silica or alumina.

4. Process according to claim 1, wherein the materials for the beds, where hydrogen chloride and sulfur oxides are absorbed, are selected from oxides, hydroxides, carbonates, hydrogen carbonates and hydroxy carbonates of alkali metals or alkaline earth metals dispersed on carriers selected from alumina, silica and titania or mixtures thereof.

5. Process according to claim 4, wherein the alkali metals and alkaline earth metals are selected from potassium, sodium, magnesium and zinc.

6. Process according to claim 4, wherein the bed for hydrogen chloride and sulfur oxides absorption is K₂CO₃ or Na₂CO₃.
